(19) United States
(12) Patent Application Publication
(10) Pub. No.: US 2023/0347816 A1
(43) Pub. Date: Nov. 2, 2023

(54) TRIM ELEMENT FOR A VEHICLE AND METHOD OF MANUFACTURING SUCH A DEVICE

(71) Applicant: FAURECIA INTERIEUR INDUSTRIE, Nanterre (FR)

(72) Inventors: Christophe CUVILLIER, SAINT OUEN L'AUMONE (FR); François PERRIN, LE PORT MARLY (FR)

(21) Appl. No.: 18/308,566

(22) Filed: Apr. 27, 2023

(30) Foreign Application Priority Data
Apr. 27, 2022 (FR) FR 2203916

(51) Int. Cl. B60Q 3/20; G02B 5/02; B60R 13/02

(52) U.S. Cl. CPC B60Q 3/20; B60R 13/02; G02B 5/0215; G02B 5/0284; B60R 2013/0287

(57) ABSTRACT

A trim element for a vehicle is proposed, comprising: a first layer comprising a surface defining a first outer surface of the trim element and an opposite surface, a decorative element arranged on the first layer, a light source arranged on the first layer, a power supply circuit for the light source, the power supply circuit being arranged on the first layer, and a transparent or translucent second layer at least partially coating the light source to direct light from the light source towards a second outer surface of the trim element which is other than the first outer surface.

### TECHNICAL FIELD

This invention relates to the field of trim elements for the passenger compartment of a vehicle, in particular of a motor vehicle. The invention relates more particularly to a trim element making use of what is referred to as “plastronic” technology.

### BACKGROUND

It is customary to illuminate certain surfaces of the passenger compartment of a vehicle, even if these do not contain actuation controls for a device. For example, the space located at the passenger’s feet, or the bottom of a storage space in the passenger compartment, can be illuminated to facilitate their use. For this purpose, a lighting device is installed in a trim element arranged in the vicinity of the area to be illuminated. The illumination produced is directed away from the user-facing surface of the trim element. This type of illumination is frequently referred to as ambiance lighting.

Conventionally, the lighting device comprises a light source, a light guide, and a printed circuit which supplies power to the light source. This sub-assembly is attached to the rear of the trim element. This solution has the disadvantages that it occupies a significant volume and that there is a large number of parts to be assembled.

There is therefore a need to offer a solution that can provide the desired function with a smaller footprint as well as with a reduced number of parts.

### SUMMARY

To this end, this invention proposes a trim element for a vehicle, comprising:
a first layer comprising a surface defining a first outer surface of the trim element and an opposite surface,
a decorative element arranged on the first layer,
a first light source arranged on the first layer,
a power supply circuit for the first light source, the power supply circuit being arranged on the first layer,
means for directing light from the first light source towards a second outer surface of the trim element which is other than the first outer surface.

The means for directing light from the first light source comprise a transparent or translucent second layer at least partially coating the first light source.

This arrangement, in which the first layer supports the decorative element, the first light source, and its power supply circuit, as well as the means for redirecting light, makes it possible to ensure the illumination of the trim element, with a small footprint and a reduced number of elements. In particular, the thickness of the trim element can be reduced.

The features listed in the following paragraphs may be implemented independently of each other, or in any technically possible combination.

The trim element is an element of the passenger compartment of a vehicle. The vehicle may for example be a motor vehicle.

The first layer is transparent or translucent.

The first layer is flexible.

The power supply circuit of the first light source is in contact with the first layer and/or with the decorative element and/or with the reflective layer.

The power supply circuit of the first light source is formed by printing conductive ink on the first layer and/or on the decorative element and/or on the reflective layer.

The decorative element may be arranged on the surface of the first layer defining a first outer surface of the trim element.

The decorative element may be arranged on the surface of the first layer which is opposite to the surface defining a first outer surface of the trim element.

The first layer may for example be made of polycarbonate (PC), polyethylene terephthalate (PET), or polycarbonate/polyethylene terephthalate copolymer (PC/PET).

The thickness of the first layer is between 50 microns and 750 microns.

The first light source comprises a light-emitting diode.

According to one embodiment, the means for directing light from the first light source are configured to direct the light from the first light source towards a second outer surface of the trim element which is opposite to the first outer surface.

In a variant, the means for directing light from the first light source are configured to direct the light from the first light source towards a second outer surface of the trim element which is adjacent to the first outer surface.

The means for directing light from the first light source comprise a reflective layer arranged on the first layer.

The reflective layer may be formed by printing ink on the first layer. The reflective layer may alternatively be formed by depositing paint on the first layer.

The reflective layer may be continuous or discontinuous.

The transparent or translucent second layer is arranged on the first layer, for example in direct contact with the first layer and/or decorative element and/or power supply circuit and/or reflective layer.

The transparent or translucent second layer coats the first light source.

The second layer is formed of an optical material. The optical material is for example clear or diffusing. The second layer is preferably formed of polycarbonate (PC), polymethyl methacrylate (PMMA), or polyethylene terephthalate (PET).

The thickness of the second layer can be between 500 microns and 5 millimeters. In particular, the thickness of the second layer can be between 1 and 5 millimeters.

The means for directing light from the first light source comprise a reflective element arranged on the first layer.

The reflective element extends facing the second layer along a direction parallel to the first layer.

The reflective element faces a side surface of the second layer.

The reflective element faces each of the side surfaces of the second layer.

The reflective element is at a distance from the second layer over at least a portion of the thickness of the second layer.

The reflective element can be at a distance from the second layer over the entire thickness of the second layer.

The distance between the reflective element and the second layer is between 0.1 millimeters and 3 millimeters.

The reflective element is in contact with the second layer at a contact surface extending over at least a portion of the thickness of the second layer.

In other words, no clearance or air gap is present between the reflective element and the second layer, at least over a portion of the thickness of the second layer. The aesthetic appearance of the trim element is improved, because no gaps are perceptible on the surface of the trim element.

The contact surface between the reflective element and the second layer is adjacent to the first layer.

The contact surface between the reflective element and the second layer forms an angle of between 60° and 90° with the first layer.

The trim element comprises a light diffuser, the second outer surface towards which the light from the first light source is directed being formed by a surface of the light diffuser.

The surface of the light diffuser towards which the light from the first light source is directed is planar.

The light diffuser has a rectangular or trapezoidal or triangular cross-section.

The light transmission rate of the diffuser is between 20% and 90%.

The light diffusion angle of the diffuser is between 5° and 60°.

The light diffuser and the second layer form a single unit.

The light diffuser and the second layer are two separate elements.

The light diffuser is in contact with the second layer.

The light diffuser is at a distance from the second layer.

The distance between the light diffuser and the second layer, in a direction perpendicular to the first layer, is between 0.1 millimeters and 3 millimeters.

According to one embodiment, the trim element comprises a second light source arranged on the first layer, the second light source being configured to illuminate the decorative element, in particular a portion of the decorative element not located next to the second layer. The power supply circuit of the second light source is for example the same as the power supply circuit of the first light source.

In this embodiment, the first layer is transparent or translucent.

In this embodiment, the second light source is configured to illuminate the decorative element without illuminating the second outer surface illuminated by the first light source. For this purpose, the trim element comprises for example a transparent or translucent third layer configured to illuminate the decorative element without illuminating the second outer surface illuminated by the first light source. The third layer is distinct from the second layer. The third layer is optically separated from the second layer by an opaque element. The third layer comprises an extraction element enabling the extraction of light from the third layer towards the decorative element.

The outer surface of the first layer, i.e. the first outer surface, can form a control interface for the vehicle’s users, for controlling components or subsystems of the vehicle. For this purpose, one or more touch sensors may be installed so that pressure from a user activates the component or subsystem.

The invention also relates to a method of manufacturing a trim element for a vehicle as described above, comprising the steps of:
(a) providing a film forming a first layer,
(b) forming a decorative element on a face of the first layer,
(c) forming a power supply circuit on a face of the first layer,
(d) forming a reflective layer on a face of the first layer,
(e) fixing a first light source to the first layer in a manner that connects the first light source to the power supply circuit,
(f) coating the first light source with a second layer arranged on the first layer.

The manufacturing method may comprise an optional step (g) of fixing a reflective element surrounding the second layer, the reflective element being for example at a distance from the second layer so as to leave a layer of air between the reflective element and the second layer.

The second layer may be injected over the first layer. The second layer may also be injected separately and then fixed to the first layer.

The first layer may be thermoformed. In other words, the first layer may be formed from a plate of thermoplastic material, which is heated and then shaped in a mold corresponding to the desired shape. Other shaping methods are also possible.

Step (d) of forming a reflective layer on a face of the first layer is optional. According to a variant embodiment, step (e) may directly follow step (c). Step (d) is then not performed.

The trim element for a vehicle may also be manufactured by other types of manufacturing methods, which will not be detailed here.

### BRIEF DESCRIPTION OF DRAWINGS

Other features, details, and advantages will become apparent upon reading the detailed description below, and upon analyzing the appended drawings, in which:

FIG. 1 is a schematic representation of a trim element according to a first embodiment of the invention,

FIG. 2 is a partial schematic view illustrating various means for redirecting light which can be implemented in the trim element of FIG. 1,

FIG. 3 is a schematic representation of a first variant of the trim element of FIG. 1,

FIG. 4 is a schematic representation of a second variant of the trim element of FIG. 1,

FIG. 5 is a schematic representation of a third variant of the trim element of FIG. 1,

FIG. 6 is a schematic representation of a fourth variant of the trim element of FIG. 1,

FIG. 7 is a schematic representation of a fifth variant of the trim element of FIG. 1,

FIG. 8 is a schematic representation of a sixth variant of the trim element of FIG. 1,

FIG. 9 is a schematic representation of a trim element according to a second embodiment,

FIG. 10 is a schematic view illustrating different steps of a method of manufacturing the trim element of FIG. 1,

FIG. 11 is a schematic view illustrating other steps in the manufacturing method.

### DETAILED DESCRIPTION

To make the figures easier to read, the various elements are not necessarily shown to scale. In these figures, identical elements bear the same references. Certain elements or parameters may be indexed, meaning they are designated for example as first element or second element, or as first parameter and second parameter, etc. The purpose of this indexing is to differentiate between similar but not identical elements or parameters. This indexing does not imply a priority of one element or parameter over another, and the designations are interchangeable. When it is specified that a subsystem comprises a given element, this does not exclude the presence of other elements in this subsystem.

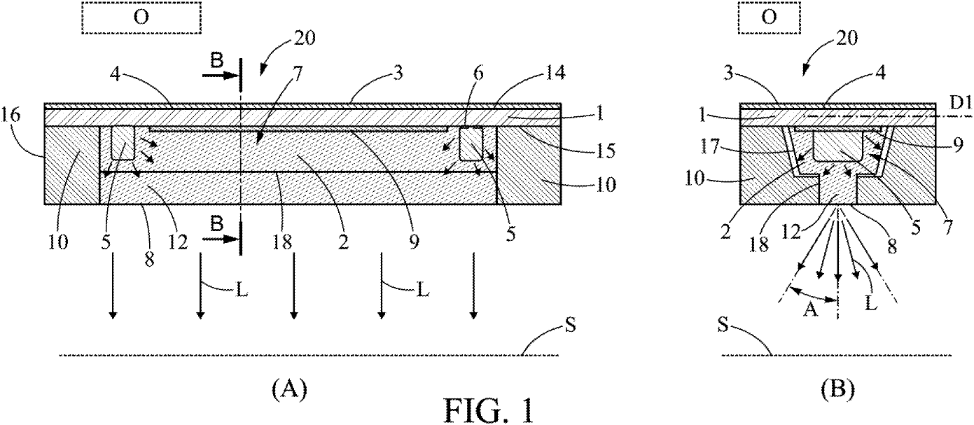

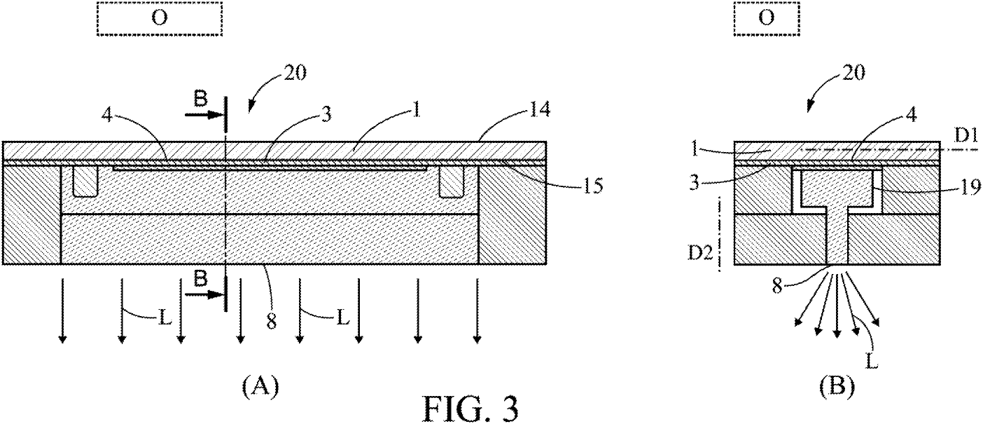

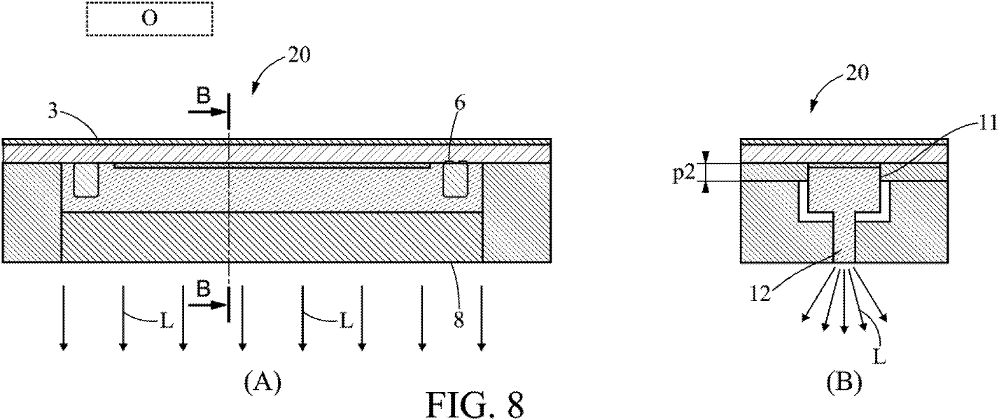

A trim element 20 for a vehicle is shown in FIG. 1. Trim element 20 is an element of the vehicle’s passenger compartment. The vehicle may for example be a motor vehicle or an industrial vehicle. The trim element is for example an armrest, or a storage compartment, or a cup holder. Part A of FIG. 1 is a front view, and part B of FIG. 1 is a side view. The same holds true for FIGS. 3 to 8.

Trim element 20 for a vehicle comprises:
a first layer 1 comprising a surface defining a first outer surface 14 of trim element 20 and an opposite surface 15,
a decorative element 3 arranged on first layer 1,
a first light source 5 arranged on first layer 1,
a power supply circuit 6 for first light source 5, power supply circuit 6 being arranged on first layer 1,
means 7 for directing light from first light source 5 towards a second outer surface 8, 8′ of trim element 20 other than first outer surface 14.

The term “outer surface” is understood to mean a surface oriented towards the passenger compartment of the vehicle. First outer surface 14 is for example intended to be directly visible to an occupant of the vehicle. Second outer surface 8, 8′ is for example not intended to be directly visible to an occupant of the vehicle when this occupant is in a posture corresponding to normal use of the vehicle while being operated. Means 7 for directing light from first light source 5 comprise a transparent or translucent second layer 2 at least partially coating first light source 5. In the example of FIG. 1, first light source 5 is completely coated by second layer 2, meaning that first light source 5 is in contact with second layer 2 over its entire outer surface, with the exception of the portion which is in contact with first layer 1. The terms “transparent or translucent” are understood to mean a light transmission rate greater than 5%. The light transmission rate may for example be greater than 20%.

This arrangement in which first layer 1 supports decorative element 3, first light source 5, and its power supply circuit 6, as well as means 7 for redirecting light, makes it possible to ensure illumination of the trim element with a small footprint and a reduced number of elements. In particular, the thickness of the trim element can be reduced compared to traditional solutions.

First layer 1 is transparent or translucent. First layer 1 is flexible. It is thus understood that first layer 1 is flexible when considered in isolation. First layer 1 may be assembled to a rigid structure, and once the assembly has been completed, the shape of the first layer 1 no longer changes.

First layer 1 is formed by a polymer film. First layer 1 may for example be made of polycarbonate (PC), polyethylene terephthalate (PET), or polycarbonate/polyethylene terephthalate copolymer (PC/PET). The thickness of first layer 1 is between 50 microns and 750 microns.

Decorative element 3 defines a visible surface of trim element 20. This means that decorative element 3 is visible to an occupant of the vehicle when the trim element is installed in the nominal position. The O symbol schematically indicates the location of the occupant, or user, when trim element 20 is installed. The L symbols schematically indicate the direction in which light is emitted. The S symbol schematically indicates the surface illuminated by the light emitted by first light source 5 and redirected by means 7 for redirecting light.

Power supply circuit 6 of first light source 5 is in contact with first layer 1. Power supply circuit 6 of first light source 5 is formed by a conductive ink on first layer 1. The conductive ink forms electrical connection tracks which are in contact with first layer 1. In other words, electrical supply circuit 6 comprises electrical connection tracks formed by a conductive ink. The electrical connection tracks are for example printed on first layer 1. Trim element 20 here has no printed circuit supplying power to first light source 5 which is separate from the electrical connection tracks formed on first layer 1.

Decorative element 3 may be arranged on a surface of first layer 1 defining a first outer surface 14 of trim element 20. In other words, in this embodiment, illustrated in FIG. 1, decorative element 3 covers first outer surface 14.

In a variant, decorative element 3 may be arranged on a surface 15 of first layer 1 which is opposite to surface 14 defining the first outer surface of trim element 20. In other words, in this variant embodiment, illustrated in particular in FIG. 3, first layer 1 covers decorative element 3. Power supply circuit 6, first light source 5, and second layer 2 are arranged on surface 15 opposite to surface 14 defining the first outer surface. Power supply circuit 6 of first light source 5 is in contact with decorative element 3 and/or with reflective layer 9.

The transparent or translucent first layer 1 and decorative element 3 together form a decorative layer. Decorative element 3 may be formed by a layer of decorative ink on first layer 1. The decorative ink layer may be on either of the faces of first layer 1. The layer of decorative ink may alternatively be paint. The portion of decorative element 3 extending next to second layer 2 may be opaque to light. Opaque is understood to mean a light transmission rate of less than 5%. The light transmission rate can be zero, i.e. equal to 0%.

The outer surface of first layer 1 may be flat, as is the case in the example shown. According to other example implementations, not shown, the outer surface of first layer 1 may be curved. The outer surface of first layer 1 may locally comprise reliefs or protuberances. The shape of the outer surface of first layer 1 is adapted to the desired shape for trim element 20.

First light source 5 comprises a light-emitting diode. A light-emitting diode is often referred to by the acronym LED. First light source 5 is arranged on opposite surface 15 of first layer 1. First light source 5 is, for example, directly in contact with first layer 1, decorative element 3, and/or reflective layer 9. Trim element 20 comprises for example several first light sources 5, for example two first light sources 5, as shown in FIGS. 1, 3 to 8, 10 and 11. Transparent or translucent second layer 2 at least partially coats first light sources 5.

According to a first embodiment as well as its variants, illustrated in FIGS. 1 to 8, the means 7 for directing light from first light source 5 are configured to direct the light from first light source 5 towards a second outer surface 8 of trim element 20 which is opposite to first outer surface 14.

First layer 1 defines an upper face of trim element 20. Second outer surface 8, from which the light is emitted, defines a lower face of trim element 20.

First outer surface 14 and second outer surface 8 extend in substantially parallel planes.

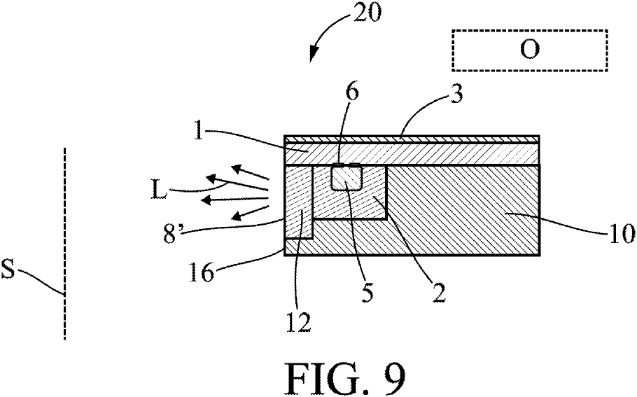

According to a second embodiment, illustrated in FIG. 9, means 7 for directing light from first light source 5 are configured to direct the light from first light source 5 towards a second outer surface 8′ of trim element 20 which is adjacent to decorative element 3. In the case where first layer 1 defines an upper face of trim element 20, second outer surface 8′ towards which the light from first light source light 5 is directed is in this case a side surface 16 of trim element 20.

Second outer surface 8′ towards which the light from first light source 5 is directed can form an angle of between 30° and 90° with decorative element 3. In the example of FIG. 9, this angle is 90°.

Means 7 for directing light from first light source 5 comprise a reflective layer 9 arranged on first layer 1. Reflective layer 9 reflects the light emitted by first light source 5, towards transparent or translucent second layer 2. Reflective layer 9 thus contributes to directing the light emitted by first light source 5 towards second outer surface 8, 8′. Reflective layer 9 blocks for example the transmission of light through first layer 1 and towards decorative element 3. Reflective layer 9 thus prevents unwanted illumination of decorative element 3. Reflective layer 9 is for example formed by reflective ink printed on first layer 1. Reflective layer 9 may alternatively be formed by depositing reflective paint on first layer 1. Reflective layer 9 may be continuous or discontinuous. Reflective layer 9 is arranged on surface 15 opposite to the surface defining first outer surface 14. Reflective layer 9 extends facing second layer 2 along a direction perpendicular to first layer 1. Reflective layer 9 extends for example between first layer 1 and second layer 2.

Transparent or translucent second layer 2 coats first light source 5. Transparent or translucent second layer 2 is arranged on first layer 1.

Second layer 2 is preferably formed of an optical material. The optical material is for example clear or diffusing. The second layer is preferably formed of polycarbonate (PC), polymethyl methacrylate (PMMA), or polyethylene terephthalate (PET). The thickness of the second layer 2 can be between 500 microns and 5 millimeters. In particular, the thickness of the second layer 2 can be between 1 and 5 millimeters.

Means 7 for directing light from first light source 5 comprise a reflective element 10 arranged on first layer 1. Reflective element 10 is arranged on opposite surface 15 of first layer 1. Reflective element 10 extends facing second layer 2 along a direction D1 parallel to first layer 1.

In the example of FIG. 1, reflective element 10 is facing a side surface 17 of second layer 2. More specifically, reflective element 10 is facing each of side surfaces 17 of second layer 2. Reflective element 10 thus surrounds second layer 2.

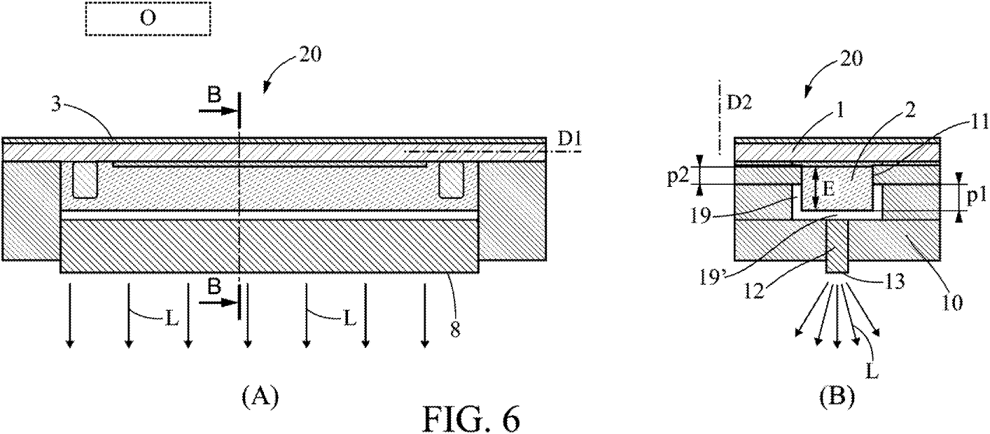

Reflective element 10 may be at a distance from second layer 2, at least over a portion of thickness E of second layer 2. In the example of FIG. 6, reflective element 10 is at a distance from second layer 2 over a portion p1 of thickness E of second layer 2. Thickness E of second layer 2 is understood to mean the dimension measured in a direction D2 perpendicular to first layer 1.

According to the alternative embodiments illustrated in FIGS. 3 to 5, reflective element 10 is at a distance from second layer 2 over the entire thickness E of second layer 2.

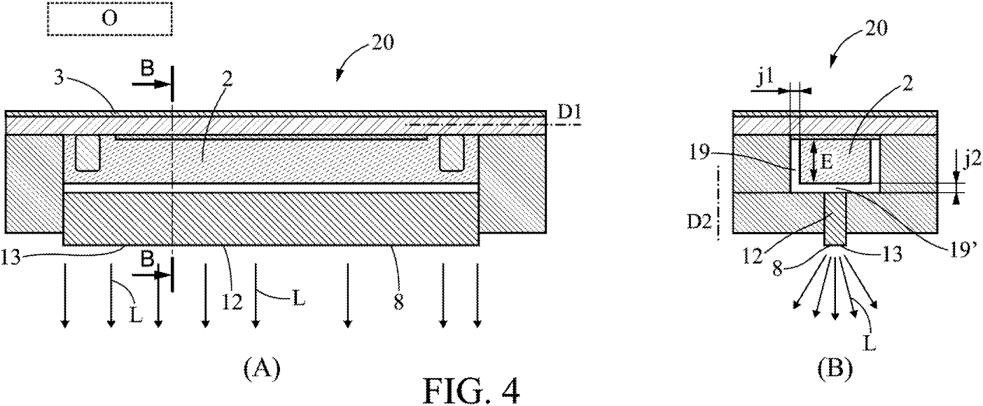

The distance j1 between reflective element 10 and second layer 2 is between 0.1 millimeters and 3 millimeters. Distance j1, illustrated in FIG. 4, is measured in a plane parallel to first layer 1. A layer of air 19 is thus present between second layer 2 and reflective element 10, at least along a portion p1 of thickness E of second layer 2.

In the variants illustrated in FIGS. 6, 7, 8, reflective element 10 is in contact with second layer 2 at a contact surface 11 extending over at least a portion p2 of thickness E of second layer 2. In other words, no clearance or air gap is present between reflective element 10 and second layer 2, at least over portion p2 of the thickness of second layer 2. The aesthetic appearance of the trim element is improved, since no gap is perceptible to the user at the surface of trim element 20.

Contact surface 11 between reflective element 10 and second layer 2 is adjacent to first layer 1. In the example of FIG. 6, contact surface 11 between reflective element 10 and second layer 2 forms an angle of between 60° and 90° with first layer 1.

Trim element 20 comprises a light diffuser 12, the second outer surface 8, 8′ towards which the light from first light source 5 is directed being formed by a surface 13 of light diffuser 12. In the example illustrated, surface 13 of light diffuser 12 towards which the light from first light source 5 is directed is planar. According to variants not shown, surface 13 of light diffuser 12 may be concave or convex.

The light transmission rate of diffuser 12 is between 20% and 90%. The light diffusion angle A of diffuser 12 is between 5° and 60°.

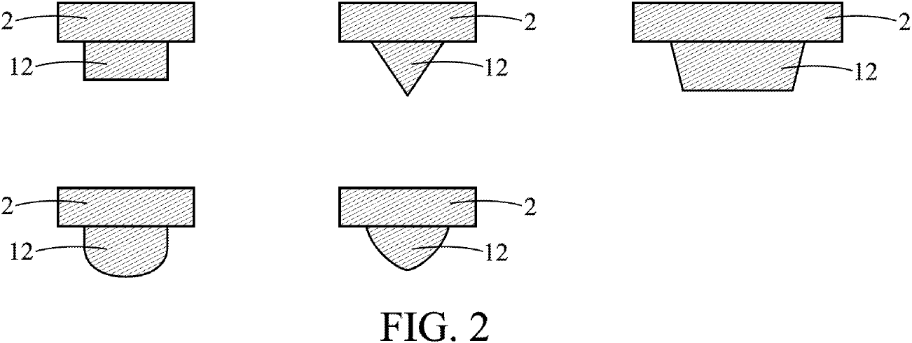

Light diffuser 12 has a rectangular or trapezoidal or triangular cross-section. FIG. 2 shows several examples of cross-sections of light diffuser 12. Other shapes, not shown, are also possible.

In the variant embodiments illustrated in FIGS. 1, 3, 8, light diffuser 12 and second layer 2 form a single unit.

According to the variant embodiments of FIGS. 4 to 7, light diffuser 12 and second layer 2 are two separate elements.

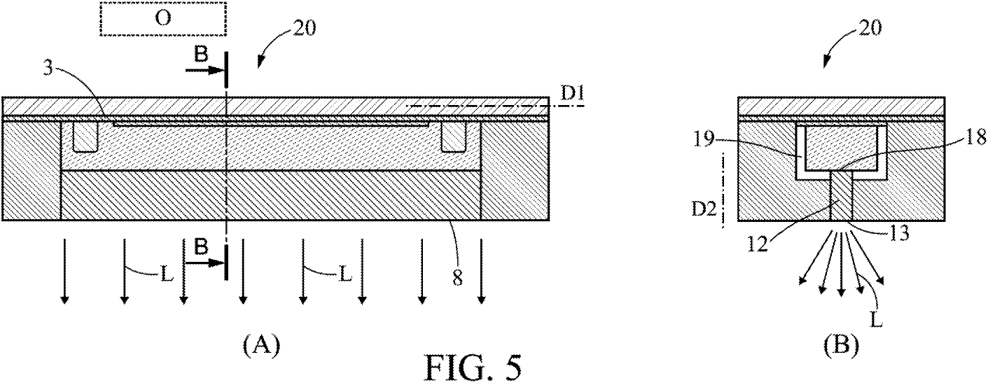

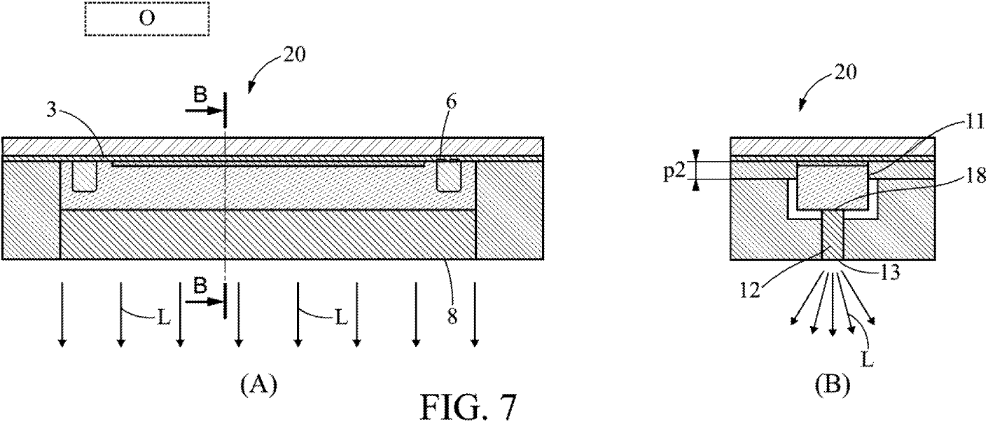

In the variant embodiments of FIGS. 5 and 7, light diffuser 12 is in contact with second layer 2.

The contact surface between light diffuser 12 and second layer 2 is indicated by the reference 18, which can be seen for example in FIGS. 5 and 7.

According to some variant embodiments, light diffuser 12 may be at a distance from second layer 2. This case is illustrated in FIGS. 4 and 6.

FIG. 4 shows the distance j2 existing between light diffuser 12 and second layer 2, in a direction D2 perpendicular to first layer 1. Distance j2 is for example between 0.1 millimeters and 3 millimeters. A layer of air 19′ of thickness j2 is thus present along direction D2, between light diffuser 12 and second layer 2.

According to an embodiment not shown, trim element 20 comprises a second light source arranged on first layer 1, the second light source being configured to illuminate decorative element 3, in particular a portion of decorative element 3 not located next to the second layer. The second light source is arranged on opposite surface 15 of first layer 1. Power supply circuit 6 of the second light source is for example the same as the power supply circuit of first light source 5. In this embodiment, the first layer is transparent or translucent.

The second light source is configured to illuminate decorative element 3 without illuminating second outer surface 8, 8′ which is illuminated by first light source 5. For this purpose, trim element 20 comprises for example a transparent or translucent third layer configured to illuminate decorative element 3 without illuminating second outer surface 8, 8′ illuminated by first light source 5. The third layer is distinct from the second layer. The third layer is arranged on first layer 1, in particular on opposite surface 15 of first layer 1. The third layer is optically separated from the second layer by an opaque element. The opaque element forms a screen preventing the light emitted by the second light source from illuminating second outer surface 8, 8′ illuminated by first light source 5. In other words, the opaque element prevents the area to be illuminated by the second light source from receiving stray light emitted by first light source 5. In the same manner, the opaque element prevents the area to be illuminated by first light source 5 from receiving stray light coming from the second light source. The third layer comprises an optical extraction element enabling the extraction of light from the third layer towards the decorative element. According to this embodiment, decorative element 3 is for example opaque in a portion extending next to second layer 2 and at least partially transparent or translucent in a portion extending next to the third layer. Thus, the second light source is able to backlight one or more patterns formed by the transparent or translucent portions of decorative element 3.

The outer surface of first layer 1, i.e. first outer surface 14, may form a control interface for the vehicle’s users, for controlling components or subsystems of the vehicle. For this purpose, one or more touch sensors may be installed so that pressure from a user activates the corresponding component or subsystem.

The disclosure also relates to a method of manufacturing a trim element (20) for a vehicle as described above, comprising the steps of:
(a) providing a film forming a first layer 1,
(b) forming a decorative element 3 on a face of first layer 1,
(c) forming a power supply circuit 6 on a face of first layer 1,
(d) forming a reflective layer 9 on a face of first layer 1,
(e) fixing a first light source 5 to first layer 1,
(f) coating first light source 5 with a second layer 2 arranged on first layer 1.

Optionally, the manufacturing method comprises a step (g) of fixing a reflective element 10 surrounding second layer 2, reflective element 10 being for example at a distance from second layer 2 so as to leave a layer of air between reflective element 10 and second layer 2.

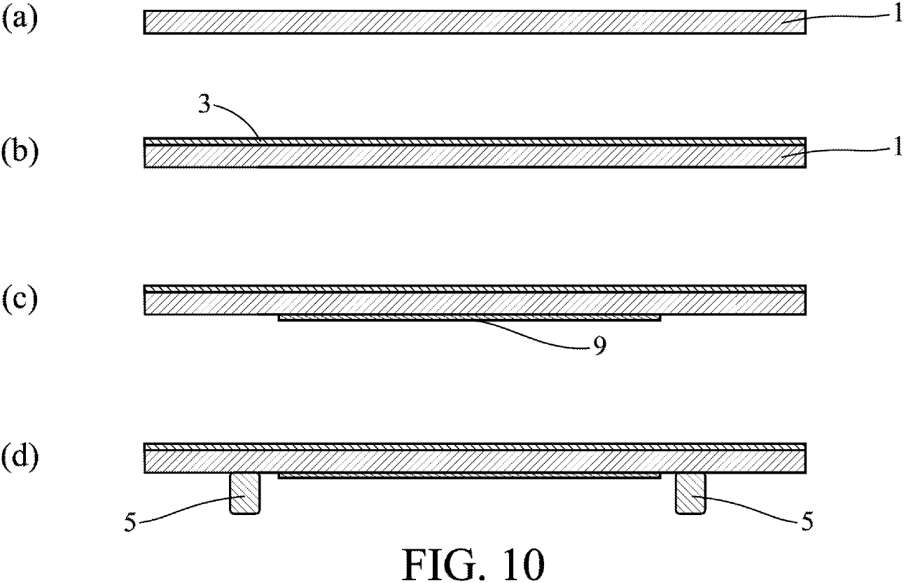

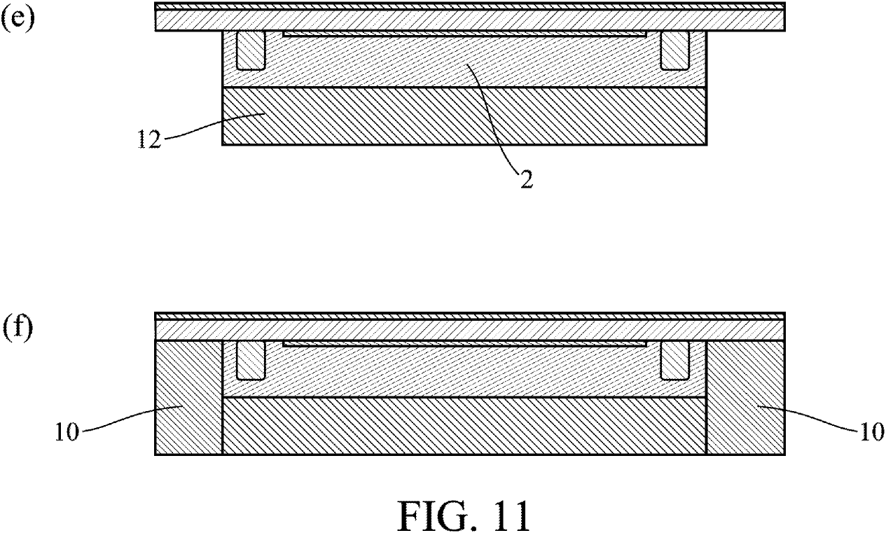

FIGS. 10 and 11 illustrate the different steps of the method, with the corresponding reference symbols.

Second layer 2 may be injected onto first layer 1. Second layer 2 may also be injected separately, then fixed to first layer 1.

First layer 1 may be thermoformed. In other words, first layer 1 may be formed from a plate of thermoplastic material, which is heated and then shaped in a mold corresponding to the desired shape. Other methods of shaping first layer 1 are also possible.

Step (d) of forming a reflective layer 9 on one side of first layer 1 is optional. According to a variant embodiment, step (e) may directly follow step (c). Step (d) is then not performed.

Trim element 20 may also be manufactured by other types of manufacturing methods, which will not be detailed here.

1. A trim element for a vehicle, comprising:
a first layer comprising a surface defining a first outer surface of the trim element and an opposite surface,
a decorative element arranged on the first layer,
a first light source arranged on the first layer,
a power supply circuit for the first light source, the power supply circuit being arranged on the first layer,
means for directing light from the first light source towards a second outer surface of the trim element which is other than the first outer surface, the means for directing light from the first light source comprising a transparent or translucent second layer at least partially coating the first light source.

2. The trim element according to claim 1, wherein the means for directing light from the first light source are configured to direct the light from the first light source towards a second outer surface of the trim element which is opposite to the first outer surface .

3. The trim element according to claim 1, wherein the means for directing light from the first light source are configured to direct the light from the first light source towards a second outer surface of the trim element which is adjacent to the first outer surface.

4. The trim element according to claim 1, wherein the means for directing light from the first light source comprise a reflective layer arranged on the first layer.

5. The trim element according to claim 1, wherein the means for directing light from the first light source comprise a reflective element arranged on the first layer, the reflective element extending facing the second layer along a direction parallel to the first layer.

6. The trim element according to claim 5, wherein the reflective element is at a distance from the second layer over at least a portion of the thickness of the second layer.

7. The trim element according to claim 5, wherein the reflective element is in contact with the second layer at a contact surface extending over at least a portion of the thickness of the second layer, wherein the contact surface between the reflective element and the second layer is adjacent to the first layer.

8. The trim element according to claim 1, comprising a light diffuser, the second outer surface towards which the light of the first light source is directed being formed by a surface of the light diffuser.

9. The trim element according to claim 8, wherein the light diffuser is in contact with the second layer.

10. The trim element according to claim 8, wherein the light diffuser is at a distance from the second layer.

11. A trim element for a vehicle, comprising:
a first layer comprising a surface defining a first outer surface of the trim element and an opposite surface,
a decorative element arranged on the first layer,
a first light source arranged on the first layer,
a power supply circuit for the first light source, the power supply circuit being arranged on the first layer, and
a transparent or translucent second layer at least partially covering the first light source, wherein the second layer directs light from the first light source towards a second outer surface of the trim element which is other than the first outer surface.
